(19) United States
(12) Patent Application Publication
(10) Pub. No.: US 2013/0222679 A1
(43) Pub. Date: Aug. 29, 2013

(54) LENS MODULE AND METHOD OF ASSEMBLING LENS MODULE

(71) Applicants: Chun-Ming CHEN, Tu-Cheng (TW); Di WU, Shenzhen City (CN)

(72) Inventors: Chun-Ming CHEN, Tu-Cheng (TW); Di WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/494,037

(22) Filed: Jun. 12, 2012

(30) Foreign Application Priority Data
Feb. 27, 2012 (CN) 201210045052.1

(51) Int. Cl. H04N 5/225; B23Q 17/00

(52) U.S. Cl. 348/360; 29/407.04; 348/E05.028

(57) ABSTRACT

A lens module includes a lens holder, a lens barrel, and an image sensor. The lens barrel is received in the lens holder and includes a top surface and a bottom surface opposite to the top surface. At least three positioning poles extend downward from the bottom surface. Each of the positioning poles includes an end surface facing away the bottom surface, and center points of the at least three positioning poles form a positioning circle. A center of the positioning circle is coaxial to an optical axis of the lens barrel. The image sensor module supports the lens holder, and the center of the positioning circle is located in an optical axis of the image sensor module.

### BACKGROUND

1. Technical Field

The present disclosure relates to lens modules and, particularly, to a lens module capable of being more accurately assembled and a method of assembling the lens module.

2. Description of Related Art

Lens modules generally include a lens holder, a lens barrel, and an image sensor module. The lens holder is positioned on the image sensor module and the lens barrel is received and held in the lens holder. To obtain high quality images, it is required that the optical axis of the lens barrel is aligned with that of the image sensor module. However, limited by the assembling precision between the lens holder and the image sensor module, it is not uncommon that the lens barrel which is held and thus positioned by the lens holder is or becomes tilted relative to the image sensor module. The assembly accuracy of the lens module is often less than satisfactory.

Therefore, it is desirable to provide a lens module, which can overcome the limitations described.

### BRIEF DESCRIPTION OF THE DRAWINGS

FIG. 1 is an isometric, exploded, and schematic view of a lens module in accordance with an exemplary embodiment.

FIG. 2 is an assembled view of the lens module of FIG. 1.

FIG. 3 is a cross-sectional view taken along a line of FIG. 2.

FIG. 4 is an assembled view of a lens holder of the lens module of FIG. 1.

FIG. 5 is a flowchart of an assembling method in accordance with an exemplary embodiment.

### DETAILED DESCRIPTION

Embodiments of the disclosure will be described with reference to the drawings.

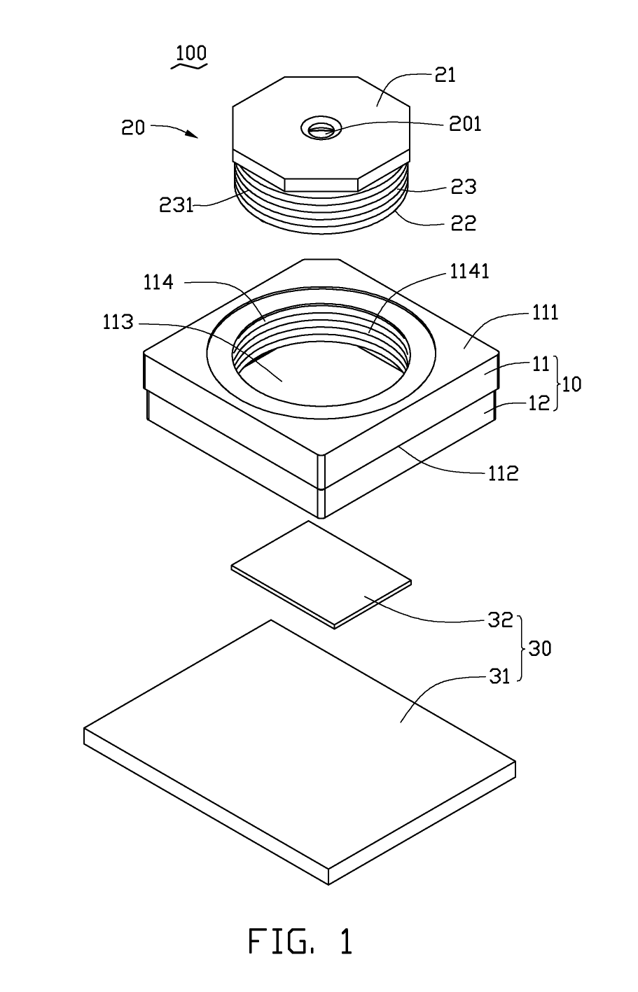

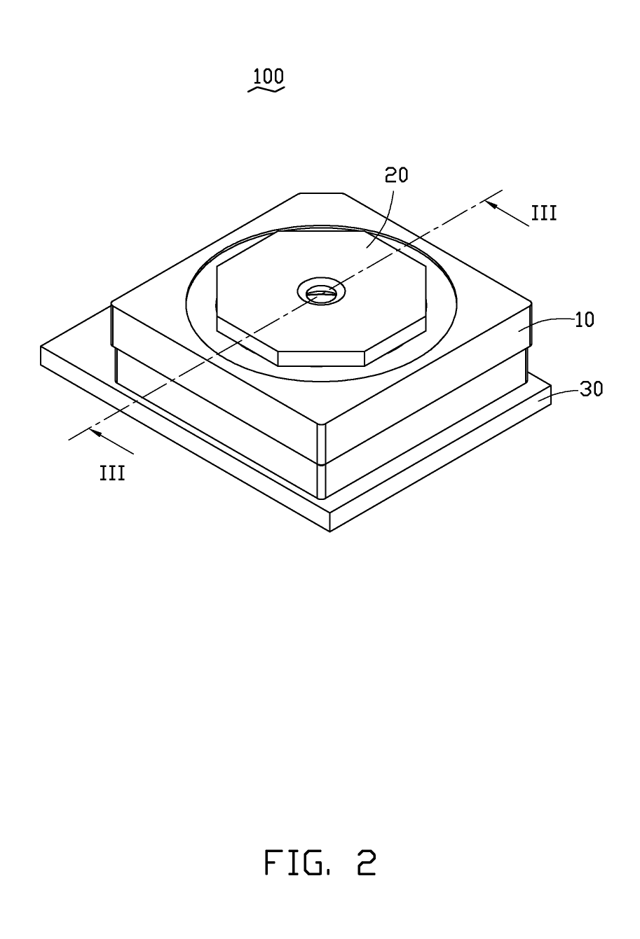

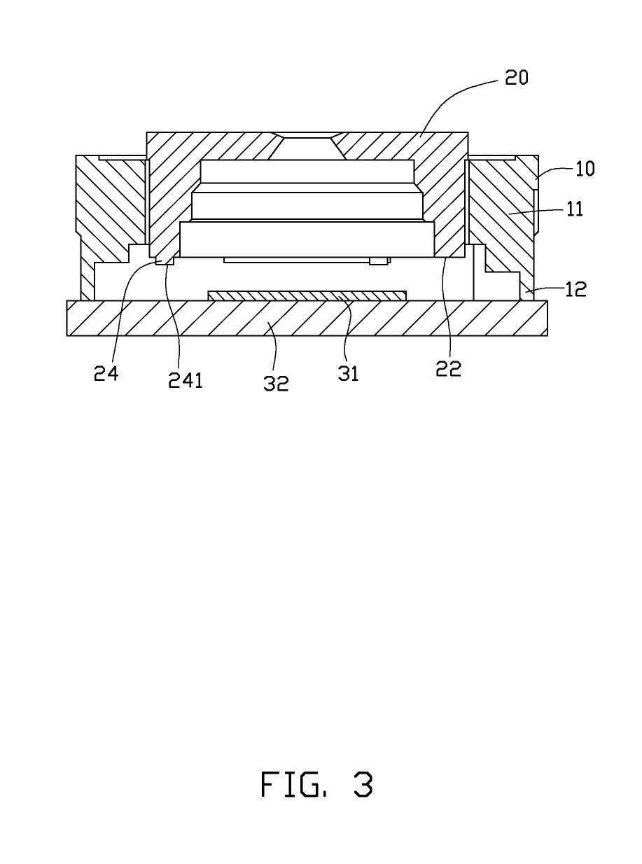

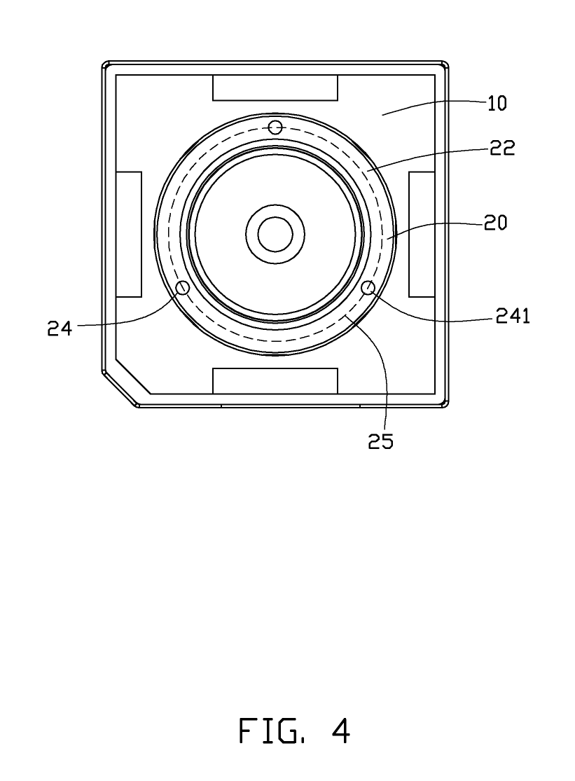

Referring to FIGS. 1-4, a lens module 100, according to an exemplary embodiment, includes a lens holder 10, a lens barrel 20, and an image sensor module 30. The lens barrel 20 is received in the lens holder 10. One end of the lens holder 10 is positioned upon the image sensor module 30.

The lens holder 10 is square-shaped and includes a receiving portion 11 and a frame portion 12. The receiving portion 11 includes an upper surface 111 and a lower surface 112 opposite to the upper surface 111. The frame portion 12 is positioned on edges of the lower surface 112. The receiving portion 11 defines a through hole 113 extending from the upper surface 111 to the lower surface 112. The through hole 113 is cylinder-shaped and is bounded by an inner circumferential surface 114. The lens holder 10 is internally threaded and defines an internal screw thread 1141 on the inner circumferential surface 114.

The lens barrel 20 is cylinder-shaped and includes a top surface 21, a bottom surface 22, and an outer circumferential surface 23. The bottom surface 22 is opposite to the top surface 21, and the outer circumferential surface 23 connects the top surface 21 to the bottom surface 22. The lens barrel 20 defines a receiving hole 201 extending from the top surface 21 to the bottom surface 22. At least one lens (not shown) is received in the receiving hole 201.

At least three positioning poles 24 perpendicularly extend downward from the bottom surface 22, generally surrounding the receiving hole 201. An extending direction of the positioning poles 24 is substantially parallel with an optical axis of the lens barrel 20. Each of the positioning poles 24 includes an end surface 241 facing away from the bottom surface 22. The end surfaces 241 are circular, and each of the end surfaces 241 has a center point. The center points of the end surfaces 241 form a positioning circle 25. The center points of the end surfaces 241 are located at a circumference of the positioning circle 25. A center of the positioning circle 25 is located at the optical axis of the lens barrel 20. The lens barrel 20 is externally threaded and defines an external screw thread 231 on the outer circumferential surface 23.

The image sensor module 30 includes a support plate 31 and an image sensor 32 supported on the support plate 31. The support plate 31 is a printed circuit board (PCB), and the image sensor 32 is electrically connected to the support plate 31. The image sensor 32 is configured for converting light rays projected thereon to image signals.

During the process of assembling the lens module 100, the lens barrel 20 is screwed into the through hole 113 of the lens holder 10, and the internal screw thread 1141 meshes with the external screw thread 231. The positioning poles 24 are protruded from the lower surface 112. The lens holder 10 is positioned upon the support plate 31, and the image sensor 32 is received in the frame portion 12. The center of the positioning circle 25 is located at an optical axis of the image sensor 32. In this embodiment, the lens holder 10 and the support plate 31 are connected by glue.

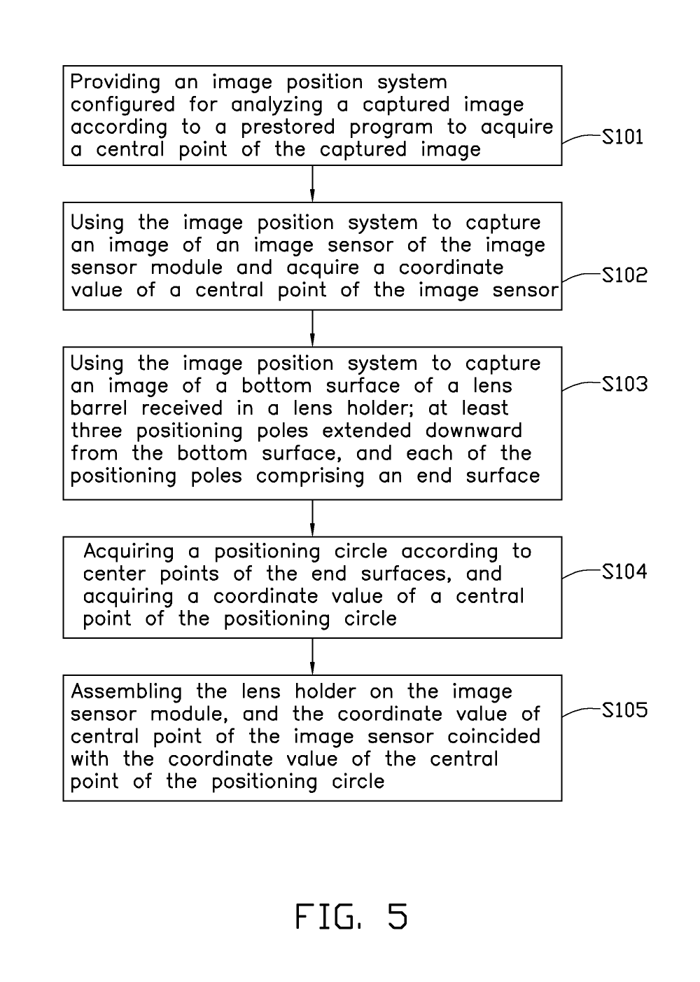

Referring to FIG. 5, a method of assembling the lens module 100 includes steps S101-S105.

S101: an image position system is provided, and the image position system is configured for analyzing a captured image according to a prestored program to acquire a central point of the captured image. The image position system has the functions of capturing an image and analyzing a captured image. The image position system applies an XY coordinate system to the images it analyzes. The prestored program is wrote in C++ or java.

S102: the image position system captures an image of the image sensor 32 supported on the support plate 31, for acquiring a coordinate value (X1, Y1) of the central point of the image sensor 32.

S103: the image position system captures an image of a bottom surface 22 of the lens barrel 20 received in the lens holder 10; at least three positioning poles 24 perpendicularly extend down from the bottom surface 22, and each of the positioning poles 24 includes an end surface 241 facing away from the bottom surface 22.

S104: the image position system acquires the positioning circle 25 according to center points of the end surfaces 241 of the at least three positioning poles 24 and acquires a coordinate value (X2, Y2) of the central point of the positioning circle 25.

S105: the lens holder 10 is assembled on the support plate 11 by the image position system using the coordinate value (X1, Y1) and the coordinate value (X2, Y2) to achieve coaxial alignment.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A lens module, comprising:
a lens holder;
a lens barrel received in the lens holder, the lens barrel comprising a top surface and a bottom surface opposite to the top surface, the lens barrel comprising at least three positioning poles extending downward from the bottom surface, each of the positioning poles comprising an end surface facing away from the bottom surface, center points of the end surfaces of the at least three positioning poles forming a positioning circle, a center of the positioning circle located in an optical axis of the lens barrel; and
an image sensor module supporting the lens holder, the center of the positioning circle located in an optical axis of the image sensor module.

2. The lens module of claim 1, wherein the lens holder comprises a receiving portion and a frame portion, the receiving portion comprises an upper surface and a lower surface opposite to the upper surface, the frame portion is position at edges of the lower surface.

3. The lens module of claim 2, wherein the receiving portion defines a through hole extending from the upper surface to the lower surface, the lens barrel is received in the through hole, and the at least three positioning poles protrude from the lower surface.

4. The lens module of claim 1, wherein the at least three positioning poles surround the receiving hole.

5. The lens module of claim 1, wherein an extending direction of the at least three positioning poles is parallel with the optical axis of the lens barrel.

6. The lens module of claim 1, wherein the end surfaces are circular, and the center points of the end surfaces are located at a circumference of the positioning circle.

7. The lens module of claim 1, wherein the image sensor module comprises a support plate and an image sensor supported on the support plate.

8. A method of assembling a lens module, the lens module comprising a lens holder, a lens barrel, and an image sensor module, the lens barrel received in the lens holder and comprising a top surface and a bottom surface opposite to the top surface, the lens barrel comprising at least three positioning poles extending downward from the bottom surface, each of the positioning poles comprising an end surface facing away from the bottom surface, the image sensor module comprising an image sensor, the method comprising:
capturing an image of the image sensor;
acquiring a coordinate value of a center of the image of the image sensor;
capturing an image of the bottom surface of the lens barrel;
acquiring a positioning circle according to center points of the end surfaces, and acquires a coordinate value of a central point of the positioning circle; and
assembling the lens holder on the image sensor module, with the coordinate value of the center of the image sensor coinciding with the coordinate value of the center point of the positioning circle.
